(19) United States
(12) Patent Application Publication
(10) Pub. No.: US 2024/0055575 A1
(43) Pub. Date: Feb. 15, 2024

(54) METHOD OF PREPARING NEGATIVE ELECTRODE FOR RECHARGEABLE LITHIUM BATTERY AND RECHARGEABLE LITHIUM BATTERY INCLUDING NEGATIVE ELECTRODE

(71) Applicants: SAMSUNG SDI CO., LTD., Yongin-si, Gyeonggi-do (KR); Korea University Research and Business Foundation of Korea University, Seoul (KR)

(72) Inventors: Gwangwon PARK, Yongin-si (KR); Won-Gi AHN, Yongin-si (KR); Min-young JEONG, Yongin-si (KR); Taeil LEE, Yongin-si (KR); Juhye BAE, Yongin-si (KR); Jin Seok PARK, Yongin-si (KR); Hyun Wook JUNG, Seoul (KR); Kwan Young LEE, Seoul (KR)

(21) Appl. No.: 18/230,009

(22) Filed: Aug. 3, 2023

(30) Foreign Application Priority Data
Aug. 3, 2022 (KR) 10-2022-0096844

(51) Int. Cl. H01M 4/04; H01M 4/13; H01M 4/139

(52) U.S. Cl. CPC H01M 4/0404; H01M 4/13; H01M 4/139; H01M 2004/027

(57) ABSTRACT

A method of preparing a negative electrode for a rechargeable lithium battery and a rechargeable lithium battery including the negative electrode, and the method of preparing the negative electrode may include preparing an active material layer on a current collector so that a coated portion in which the active material layer is formed and an uncoated region in which an active material is not formed are alternatively arranged, the active material, wherein the coated portion is formed by coating a first negative active material layer composition having a capillary number of about 0.25 to about 1.50 on the current collector and coating a second negative active material layer composition having a capillary number of about 0.28 to about 1.50 on the first negative active material layer composition.

### CROSS-REFERENCE TO RELATED APPLICATION

This application claims priority to and the benefit of Korean Patent Application No. 10-2022-0096844, filed in the Korean Intellectual Property Office on Aug. 3, 2022, the entire content of which is incorporated herein by reference.

### BACKGROUND

### 1. Field

Embodiments of the present disclosure described herein are related to a method of preparing a negative electrode for a rechargeable lithium battery and a rechargeable lithium battery including a negative electrode.

### 2. Description of the Related Art

Recently, the rapid development of electronic devices, such as mobile phones, laptop computers, and/or electric vehicles, use has led to an increase in demand for rechargeable batteries with relatively high in capacity and relatively light in weight.

Such rechargeable lithium batteries may be widely utilized in one or more suitable forms such as in the forms of cylindrical batteries, pouch batteries, and/or the like. In the preparation of electrode utilized in the battery, a pattern coating is mainly applied if (e.g., when) coating an electrode slurry on a current collector. The pattern coating is performed by coating an electrode slurry on a part of a current collector to form an active material layer and to form uncoated region in which an active material is not formed and it is essential or desire that the active material layer, i.e. coated region, and uncoated region, i.e. no-coated region are accurately coated to a designed or desired length. Furthermore, it is important to control the coating speed and drag of the end portion of the coating according to the discharge and interruption of the slurry.

### SUMMARY

An aspect according to one or more embodiments is directed toward a method of preparing a negative electrode for a rechargeable lithium battery, effectively capable of performing a pattern coating.

An aspect according to one or more embodiments is directed toward a rechargeable lithium battery including the negative electrode prepared by the method.

Additional aspects will be set forth in part in the description which follows and, in part, will be apparent from the description, or may be learned by practice of the presented embodiments of the disclosure.

According to an embodiment, a method of preparing a negative electrode for a rechargeable lithium battery may include preparing an active material layer on a current collector so that a coated (coating) portion in an active material layer is formed and an uncoated region in which an active material is not formed are alternatively arranged, wherein the coated portion in which the active material layer is formed is performed by coating a first negative active material layer composition having a capillary number of about 0.25 to about 1.50 on the current collector and coating a second negative active material layer composition having a capillary number of about 0.28 to about 1.50 on the first negative active material layer composition.

The coating the first negative active material layer composition on the current collector and the coating the second negative active material layer composition on the first negative active material layer composition may be concurrently (e.g., simultaneously) performed.

The first negative active material layer composition may have a solid content (e.g., amount of the composition that is in solid form) of about 42 wt % to about 80 wt % based on the total 100 wt %, of the first negative active material layer composition, and the second negative active material layer composition may have a solid content (e.g., amount) of about 41 wt % to about 80 wt % based on the total 100 wt %, of the second negative active material layer composition.

The first negative active material layer composition may include a first thickener and an amount of the first thickener may be about 0.006 wt % to about 0.012 wt % based on the total 100 wt %, of the first negative active material layer composition, and the second negative active material layer composition may include a second thickener and an amount of the second thickener may be about 0.007 wt % to about 0.013 wt % based on the total 100 wt %, of the second negative active material layer composition.

The first negative active material layer composition may have a capillary number of about 0.25 to about 0.82. In some embodiments, the second negative active material layer composition may have a capillary number of about 0.28 to about 0.85.

A difference of the capillary number between the first negative active material layer composition and the second negative active material layer composition may be about 0.03 to about 1.25.

According to an embodiment, a rechargeable lithium battery may include the negative electrode prepared by the method; a positive electrode; and an electrolyte.

The method of preparing the negative electrode according to one embodiment may effectively perform a pattern coating and may uniformly prepare an active material layer.

### BRIEF DESCRIPTION OF THE DRAWINGS

FIG. 1 is a schematic diagram showing a rechargeable lithium battery according to one embodiment.

FIG. 2 is a drawing showing a length of drag occurred in the negative electrode preparation of the rechargeable lithium battery.

FIG. 3 is an image for preparing the negative electrode according to Example 1.

FIG. 4 is an image showing drag occurred during the preparation the negative electrode according to Comparative Example 1.

### DETAILED DESCRIPTION

Hereinafter, embodiments of the present disclosure are described in more detail. However, these embodiments are merely examples, the present disclosure is not limited thereto, and the present disclosure is defined by the scope of claims.

A method of preparing a negative electrode for a rechargeable lithium battery according to one embodiment includes preparing an active material layer on a current collector so as to alternatively arrange a coated region in which an active material layer is formed and an uncoated region in which an active material layer is not formed.

Generally, the negative electrode preparation including the coating of an active material layer composition on a current collector may be classified as a stripe process or a pattern process.

The negative electrode preparation according to one embodiment relates to a pattern process in which (1) a coated region that is formed by coating an active material composition on a current collector and (2) an uncoated region that is alternatively formed with the coated region and does not have the coating of the active material composition.

The stripe process refers to a process in which a coating is continuously formed in the direction of moving a current collector.

Such a stripe process and a pattern process should be understood to one of ordinary skilled in the related art.

The negative electrode preparation according to one embodiment may include, in the pattern coating, that the coated region, in which the active material layer is formed, may be prepared by coating a first negative active material layer composition with a capillary number (Ca) of about 0.25 to about 1.50 on the current collector and coating a second negative active material layer composition with a capillary number of about 0.28 to about 1.50 on the first negative active material layer composition.

In one embodiment, the coating the first negative active material layer composition on the current collector and the coating the second negative active material layer composition on the first negative active material layer composition may be concurrently (e.g., simultaneously) performed. As such, the concurrent or simultaneous coating may sequentially form the first active material layer and the second active material layer on the current collector.

If (e.g., when) the first negative active material layer composition and the second negative active material layer composition have the capillary numbers within the ranges, the problems related to dragging end portion of the coated portion that may occur due to discharging and discharge stopping of composition for forming the coated region and the uncoated region during the pattern coating may be effectively prevented or reduced.

The problems of dragging the end portion of the coated portion refers to the phenomenon if (e.g., when) the application of the composition is stopped at the end of the coated region, and the coating equipment is fixed, while the current collector to be coated is moved, for example, by roll to roll equipment, the composition does not immediately stop, but is dragged, forming an active material layer with a gradually decreased thickness. Such problems related to dragging may cause (1) the electrode to be discarded, (2) deterioration of electrode stability, and/or (3) electrode fire. These drag problems, in particular, as in one embodiment, may occur more severely if (e.g., when) the negative active material layer is formed in two layers, including a first negative active material layer and a second negative active material layer, and if (e.g., when) it is illustrated in more detail, the drag of the second negative active material layer corresponding to the upper portion may occur more severely, resulting in regions where only the second negative active material layer is formed.

These dragging problems do not occur if (e.g., when) the negative active material layer is formed in the stripe process, so that it may not be necessary to solve such problems if (e.g., when) the stripe process is performed.

In one embodiment, the capillary numbers of the first negative active material layer composition and the second negative active material layer composition are adjusted into the set ranges, thereby effectively preventing or reducing the drag problem. In another embodiment, the first negative active material layer composition may have a capillary number of about 0.25 to about 0.82, or about 0.25 to about 0.7, and the second negative active material layer composition may have a capillary number of about 0.28 to about 0.85, or about 0.28 to about 0.73.

In particular, the first negative active material layer composition with the capillary number of about 0.25 to about 1.50 may effectively suppress or reduce the drag problems.

If (e.g., when) the capillary number of the first negative active material layer composition is out of the range of about 0.25 to about 1.50 range, or the capillary number of the second negative active material layer composition is out of the range of about 0.28 to about 1.50, the drag in the active material layer preparation may significantly occur, the loading level of the negative active material layer in a length direction becomes substantially non-uniform, and the coating quality is deteriorated.

In one embodiment, the capillary number refers to a ratio (dimensionless process variables) of viscous force and a surface tension at an interface. The capillary number may be obtained by Equation 1.

Ca=(ηX U_{web})/σ Equation 1

(In Equation 1, U_{web} is a coating speed (m/s), η is a viscosity (mPa·s) at a shear rate in coating, and σ is a surface tension (mNm) of a slurry.

In one embodiment, such a capillary number may be obtained by adjusting time for mixing, a negative active material, a binder, a thickener, and optionally, a conductive material in the first and second negative active material layers compositions preparation.

For example, if (e.g., when) the time for mixing is performed for about 160 minutes to about 240 minutes, a first negative active material layer composition with a Ca of about 0.25 to about 1.50 may be obtained. In some embodiments, the mixing for about 170 minutes to about 240 minutes may provide a second negative active material layer composition with a Ca of about 0.28 to about 1.50 may be obtained.

In one embodiment, the difference between the capillary number of the first negative active material layer composition and the capillary number of the second negative active material layer composition may be about 0.03 to about 1.25. In another embodiment, the capillary number of the second negative active material layer composition may be about 0.03 to about 1.25 higher than the capillary number of the first negative active material layer composition. In some embodiments, the capillary number of the first negative active material layer composition may be about 0.03 to about 1.22 higher than the capillary number of the second negative active material layer composition.

In another embodiment, the capillary number may be also obtained by controlling amounts of the solids (amounts of a negative active material, a binder, a thickener, and optionally, a conductive material) in the first and the second negative active material compositions. For example, in the negative active material layer composition, if (e.g., when) an amount of the solids is about 42 wt % to about 80 wt % based on the total 100 wt % of the negative active material composition (including a solvent), a Ca may be turned to be about 0.25 to about 1.50. If (e.g., when) the amount of the solid is about 41 wt % to about 80 wt % based on the total 100 wt % of the negative active material layer composition (including a solvent), a Ca may be turned to be about 0.28 to about 1.50.

In some embodiments, the capillary number may be also obtained by controlling an amount of the thickener in the first and second negative active material layer compositions. If (e.g., when) the amount of the thickener is about 0.006 wt % to about 0.012 wt % (excluding a solvent) based on the total 100 wt % of the negative active material layer composition (excluding solvent), a Ca may be about 0.25 to about 1.50. If (e.g., when) the amount of the thickener is about 0.007 wt % to about 0.013 wt % (excluding a solvent) based on the total 100 wt % of the negative active material layer composition (excluding solvent), a Ca may be about 0.28 to about 1.50.

This process (e.g., the controlling process) will be described in more detail.

The first negative active material layer composition may include a first negative active material, a first binder and a first thickener, and the second negative active material layer composition may include a second negative active material, a second binder and a second thickener. Herein, the first negative active material layer composition may include the first thickener at an amount of 0.006 wt % to about 0.012 wt % based on the total 100 wt %, of the first negative active material layer composition, and the second negative active material layer composition may include the second thickener at an amount of about 0.007 wt % to about 0.013 wt % based on the total 100 wt %, of the second negative active material layer composition.

If (e.g., when) the amounts of the first thickener and the second thickener included in the first and second negative active material layer compositions are out of the ranges, the desired or suitable capillary numbers may be exceeded, which is not appropriate or suitable.

The first binder and the second binder may be the same or different from each other. The first binder and the second binder may bind the negative active material particles with one another and with current collector. The binder may be a non-aqueous binder, an aqueous binder, or a combination thereof. According to one embodiment, the first binder and/or the second binder may be an aqueous binder.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may be a styrene-butadiene rubber (SBR), acrylated styrene-butadiene rubber (ABR), acrylonitrile-butadiene rubber, an acryl rubber, a butyl rubber, a fluorine rubber, an ethylene oxide-included polymer, polyvinyl pyrrolidone, polypropylene, polyepichlorohydrin, polyphosphazene, an ethylene propylenediene copolymer, polyvinyl pyridine, chlorosulfonated polyethylene, latex, a polyester resin, an acryl resin, a phenol resin, an epoxy resin, polyvinyl alcohol, or a combination thereof.

The first thickener and the second thickener may be the same, or different from each other, and may be a cellulose-based compound.

The cellulose-based compound may be one or more of carboxymethyl cellulose, hydroxypropylmethyl cellulose, methyl cellulose, or alkali metal salts thereof. The alkali metal may be Na, K, or Li. The coating process may be performed by any process suitable in the related arts. Furthermore, after the coating is performed, a drying and a pressurizing may be performed by general techniques performed in the negative electrode preparation.

In one embodiment, the first negative active material layer includes a first negative active material, and the second negative active material layer includes a second negative active material, and the first negative active material and the second negative active material may be the same or different from each other. The first negative active material and the second negative active material may be a Si and carbon composite, graphite, or a combination thereof.

The Si and carbon composite may include Si particles and a first carbon-based material. The first carbon-based material may be amorphous carbon or crystalline carbon. An example of the composite may include a core in which Si particles and a second carbon-based material are mixed, and a third carbon-based material around (e.g., surrounding) the core. The second carbon-based material and the third carbon-based material may be the same or different from each other, and may be amorphous carbon or crystalline carbon.

The amorphous carbon may be pitch carbon, soft carbon, hard carbon, mesophase pitch carbide, sintered cokes, carbon fiber, or a combination thereof, and the crystalline carbon may be artificial graphite, natural graphite, or a combination thereof.

The Si particle may have a particle diameter of about 10 nm to about 30 μm, and according to one embodiment, may be about 10 nm to about 1000 nm, or according to another embodiment, may be about 20 nm to about 150 nm. If (e.g., when) the particle diameter of the Si particle is within the range, the volume expansion caused during charge and discharge may be suppressed or reduced, and a breakage of the conductive path due to crushing of particle may be prevented or reduced.

In the specification, a particle diameter may refer to an average particle diameter of particle. Herein, the average particle diameter may refer to a particle diameter (D50) by measuring cumulative volume. If (e.g., when) a definition is not otherwise provided, such a particle diameter (D50) indicates an average particle diameter (D50) where a cumulative volume is about 50 volume % in a particle distribution.

The average particle size (D50) may be measured by a method suitable to those skilled in the art, for example, by a particle size analyzer, or also by a transmission electron microscopic image or a scanning electron microscopic image. In some embodiments, a dynamic light-scattering measurement device is utilized to perform a data analysis, and the number of particles is counted for each particle size range. From this, the average particle diameter (D50) value may be easily obtained through a calculation.

If (e.g., when) the Si and carbon composite includes the Si particles and the first carbon-based material, an amount of the Si particles may be about 30 wt % to about 70 wt % (based the total 100 wt %, of the Si and carbon composite), or according to one embodiment, about 40 wt % to about 50 wt %. An amount of the first carbon-based material may be about 70 wt % to about 30 wt %, or according to one embodiment, may be about 60 wt % to about 50 wt %. If (e.g., when) the amounts of the Si particles and the first carbon-based material are within the range, high-capacity characteristic may be exhibited.

If (e.g., when) the Si and carbon composite includes a core in which Si particles and the second carbon-based material are mixed, and a third carbon-based material around (e.g., surrounding) the core, the third carbon-based material may be presented in a thickness of about 5 nm to about 100 nm. In some embodiments, the third carbon-based material may be presented in an amount of about 1 wt % to about 50 wt % based on the total 100 wt %, of the Si and carbon composite, the Si particles may be present in amount of about 30 wt % to about 70 wt % based on the total 100 wt %, of the Si and carbon composite, and the second carbon-based material may be present in an amount of about 20 wt % to about 69 wt % based on the total 100 wt %, of the Si and carbon composite. In case of satisfying the amounts of the Si particles, the third carbon-based material, and the second carbon-based material within the range, the better discharge may be exhibited, and the capacity retention may be improved.

In one embodiment, the first negative active material or the second negative active material may further include crystalline carbon. The crystalline carbon may be artificial graphite, natural graphite, or a combination thereof.

When If (e.g., when) the first negative active material or the second negative active material further includes crystalline carbon, a mixing ratio of the crystalline carbon and the Si-carbon composite may be about 0.1 wt %: 99.9 wt % to about 95.2 wt %: 4.8 wt %, about 50 wt %: 50 wt % to about 95 wt %: 5 wt %, or about 60 wt %:40 wt % to about 95 wt %:5 wt %. If (e.g., when) the mixing ratio of crystalline carbon and the Si-carbon composite is within the range, the volume expansion of the negative active material may be more effectively suppressed or reduced, and the conductivity may be more improved.

In some embodiments, the first negative active material layer composition and the second negative active material layer composition may each further include a conductive material, independently. The conductive material is included to provide electrode conductivity, and any suitable electrically conductive material may be utilized as a conductive material unless it causes a chemical change. Examples of the conductive material may be a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; and/or one or more mixtures thereof.

In one embodiment, if (e.g., when) the first negative active material layer includes the first negative active material, the first binder and the conductive material, an amount of the first negative active material may be about 94 wt % to about 99 wt % based on the total 100 wt %, of the first negative active material layer. Furthermore, if (e.g., when) the second negative active material layer includes the second negative active material, the second binder and the conductive material, an amount of the second negative active material may be about 93 wt % to about 98 wt % based on the total 100 wt % of the second negative active material layer. In some embodiments, in the first and second negative active material layers, an amount of the conductive material may be suitably balanced.

The current collector may include one selected from a copper foil, a nickel foil, a stainless steel foil, a titanium foil, a nickel foam, a copper foam, a polymer substrate coated with a conductive metal, and a combination thereof, but is not limited thereto.

A rechargeable lithium battery according to another embodiment provides the negative electrode prepared by the method, a positive electrode and an electrolyte.

The positive electrode includes a current collector and a positive active material layer formed on the current collector.

The positive active material may include lithiated intercalation compounds that reversibly intercalate and deintercalate lithium ions. For example, one or more composite oxides of a metal selected from cobalt, manganese, nickel, and a combination thereof, and lithium, may be utilized. More specifically, the compounds represented by one of the following chemical formulae may be utilized. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}Dₐ (0.90≤a≤1.8, 0≤b≤0.5, 0≤c≤0.5, 0≤a≤2); LiₐNi_{1-b-c}Co_{b}X_{c}O₂₋ₐTₐ (0.90≤a≤1.8, 0≤b≤0.5, 0≤c≤0.5, 0<a<2); LiₐNi_{1-b-c}Co_{b}X_{c}O₂₋ₐT₂ (0.90≤a≤1.8, 0≤b≤0.5, 0≤c≤0.5, 0<a<2); LiₐNi_{1-b-c}Mn_{b}X_{c}Dₐ (0.90≤a≤1.8, 0≤b≤0.5, 0≤c≤0.5, 0<a<2); LiₐNi_{1-b-c}Mn_{b}X_{c}O₂₋ₐTₐ (0.90≤a≤1.8, 0≤b≤0.5, 0≤c≤0.5, 0<a<2); LiₐNi_{1-b-c}Mn_{b}X_{c}O₂₋ₐT₂ (0.90≤a≤1.8, 0≤b≤0.5, 0≤c≤0.5, 0<a<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃(0≤f≤2); LiₐFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound, and for example, the method may include any suitable coating method such as spray coating, dipping, and/or the like, but is not illustrated in more detail because it is -suitable in the related field.

In the positive electrode, an amount of the positive active material may be about 90 wt % to about 98 wt % based on the total weight of the positive active material layer.

In one embodiment, the positive active material layer may further include a binder and a conductive material. Herein, the amount of the binder and the conductive material may be about 1 wt % to about 5 wt %, respectively based on the total amount of the positive active material layer.

The binder improves binding properties of positive electrode active material particles with one another and with a current collector. The examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene butadiene rubber, an acrylated styrene butadiene rubber, an epoxy resin, nylon, and/or the like, but are not limited thereto.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture there.

The current collector may be Al, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may be methyl acetate, ethyl acetate, n-propyl acetate, dimethyl acetate, methyl propionate, ethyl propionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. Furthermore, the ketone-based solvent may be cyclohexanone, and/or the like. The alcohol-based solvent may include ethyl alcohol, isopropyl alcohol, and/or the like, and examples of the aprotic solvent may include nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and/or the like.

The organic solvent may be utilized alone or in a mixture. If (e.g., when) the organic solvent is utilized in a mixture, the mixture ratio may be controlled or selected in accordance with a desirable battery performance.

The carbonate-based solvent may desirably include a mixture with a cyclic carbonate and a linear carbonate. The cyclic carbonate and linear carbonate are mixed together in a volume ratio of about 1:1 to about 1:9. If (e.g., when) the mixture is utilized as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

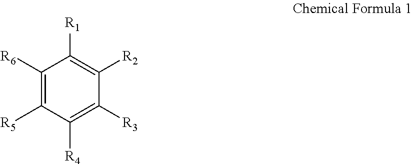

In Chemical Formula 1, R₁ to R₆ may each independently be the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylethyl carbonate, vinylene carbonate, or an ethylene carbonate-based compound represented by Chemical Formula 2, as an additive for improving cycle life.

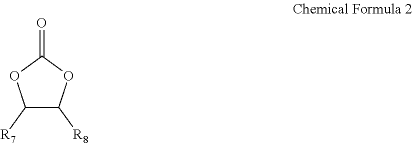

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not concurrently (e.g., simultaneously) hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. An amount of the additive for improving the cycle-life characteristics may be utilized within an appropriate or suitable range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one supporting salt selected from among LiPF₆, LiBF₄, LiSbF₆, LiAsF₆, LiN(SO₂C₂F₅)₂, Li(CF₃SO₂)₂N, LiN(SO₃C₂F₅)₂, LiF(SO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example, an integer of about 1 to about 20, lithium difluoro(bisoxolato) phosphate), LiCl, LiI, LiB(C₂O₄)₂ (lithium bis(oxalato) borate: LiBOB) and lithium difluoro(oxalato)borate (LiDFOB). A concentration of the lithium salt may range from about 0.1 M to about 2.0. If (e.g., when) the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

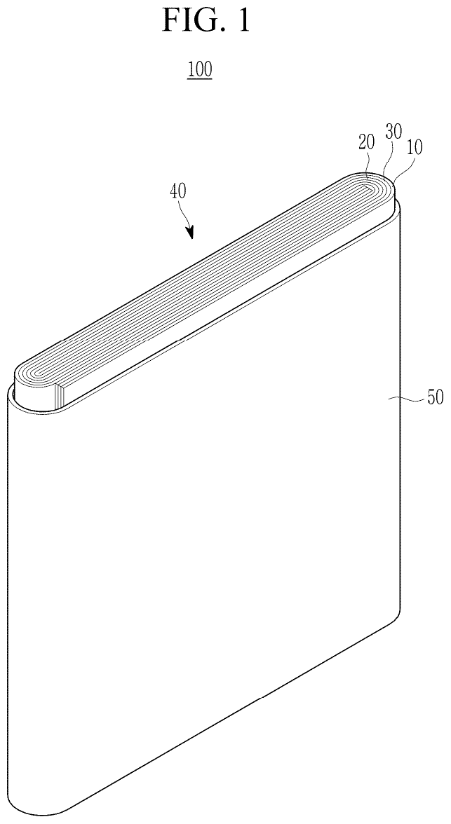

FIG. 1 is a perspective (e.g., a partial or top exploded) view of a rechargeable lithium battery according to an embodiment of the present disclosure. The rechargeable lithium battery according to an embodiment is illustrated as a prismatic battery but is not limited thereto and may include variously-shaped batteries such as a cylindrical battery, a pouch battery, and/or the like.

Referring to FIG. 1, a rechargeable lithium battery 100 according to an embodiment may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### Example 1

An artificial graphite active material and a Si—C composite active material were mixed at a weight ratio of 93:7 to prepare a negative active material. As the Si—C composite, a Si-carbon composite including a core including artificial graphite and silicon particles and a soft carbon coated on the surface of the core was utilized. The soft carbon coating layer had a thickness of 20 nm, and the silicon particles had an average particle diameter D50 of 100 nm.

A first negative active material layer slurry was prepared by mixing 96.38 wt % of the negative active material, 2.72 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 200 minutes, and adding distilled water to the resulting mixture to prepare a first negative active material layer slurry with a solid content (e.g., amount) of 48 wt %.

A second negative active material layer slurry was prepared by mixing 98.42 wt % of the negative active material, 0.68 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 200 minutes, and adding distilled water to the resulting mixture to prepare a second negative active material layer slurry with a solid content (e.g., amount) of 50 wt %.

An amount of the styrene-butadiene rubber in the first negative active material layer composition was four times the amount of the styrene-butadiene rubber in the second negative active material layer composition, and thus, an 80:20 weight ratio.

The capillary numbers of the first and the second negative active material layers slurries were calculated by Equation 1, and the results are 0.386 and 0.596.

The first negative active material layer slurry and the second negative active material layer slurry were coated and uncoated on both (e.g., opposite) sides of a Cu foil current collector, respectively, to alternatively form a coated region and an uncoated region, thereby obtaining a negative electrode.

The coated region was prepared by sequentially positioning the current collector, the first negative active material layer, and the second negative active material layer.

### Example 2

A negative electrode was prepared by the same procedure as in Example 1, except that the first negative active material layer slurry was prepared by mixing 96.28 wt % of the negative active material utilized in Example 1, 2.72 wt % of a styrene-butadiene rubber, and 1.0 wt % of a carboxymethyl cellulose aqueous solution (concentration of carboxymethyl cellulose aqueous solution: 0.01 wt % of the aqueous solution is carboxymethyl cellulose and 99.99 wt % of the aqueous solution is water) for 200 minutes, and adding distilled water to the resulting mixture to prepare a negative active material layer slurry with a solid content (e.g., amount) of 52 wt %, and

except that the second negative active material layer slurry was prepared by mixing 98.42 wt % of the negative active material utilized in Example 1, 0.68 wt % of a styrene-butadiene rubber, and 0.9 wt % of a carboxymethyl cellulose aqueous solution (concentration of carboxymethyl cellulose aqueous solution: 0.01 wt % of the aqueous solution is carboxymethyl cellulose and 99.99 wt % of the aqueous solution is water) for 200 minutes, and adding distilled water to the resulting mixture to prepare a negative active material layer slurry with a solid content (e.g., amount) of 48 wt %.

Herein, the capillary number of the first negative active material layer slurry was 0.676, and the capillary number of the second active material layer slurry was 0.473.

### Example 3

A negative electrode was prepared by the same procedure as in Example 1, except that the first negative active material layer slurry was prepared by mixing 96.38 wt % of the negative active material utilized in Example 1, 2.72 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 200 minutes, and adding distilled water to the resulting mixture to prepare a first negative active material layer slurry with a solid content (e.g., amount) of 50 wt %, and

except that the second negative active material layer slurry was prepared by mixing 98.32 wt % of the negative active material utilized in Example 1, 0.68 wt % of a styrene-butadiene rubber, and 1.0 wt % of a carboxymethyl cellulose aqueous solution (concentration of carboxymethyl cellulose aqueous solution: 0.01 wt % of the aqueous solution is carboxymethyl cellulose and 99.99 wt % of the aqueous solution is water) for 200 minutes, and adding distilled water to the resulting mixture to prepare a second negative active material layer slurry with a solid content (e.g., amount) of 52 wt %.

Herein, the capillary number of the first negative active material layer slurry was 0.507, and the capillary number of the second active material layer slurry was 0.662.

### Comparative Example 1

A negative electrode was prepared by the same procedure as in Example 1, except that the first negative active material layer slurry was prepared by mixing 96.38 wt % of the negative active material utilized in Example 1, 2.72 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 250 minutes, and adding distilled water to the resulting mixture to prepare a first negative active material layer slurry with a solid content (e.g., amount) of 41 wt %, and

except that the second negative active material layer slurry was prepared by mixing 98.42 wt % of the negative active material utilized in Example 1, 0.68 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 250 minutes, and adding distilled water to the resulting mixture to prepare a second negative active material layer slurry with a solid content (e.g., amount) of 40 wt %.

Herein, the capillary number of the first negative active material layer slurry was 0.201, and the capillary number of the second active material layer slurry was 0.223.

### Comparative Example 2

A negative electrode was prepared by the same procedures as in Example 1, except that the first negative active material layer slurry was prepared by mixing 96.33 wt % of the negative active material utilized in Example 1, 2.72 wt % of a styrene-butadiene rubber, and 0.95 wt % of a carboxymethyl cellulose aqueous solution (concentration of carboxymethyl cellulose aqueous solution: 0.0095 wt % of the aqueous solution is carboxymethyl cellulose and 99.9905 wt % of the aqueous solution is water) for 200 minutes, and adding distilled water to the resulting mixture to prepare a first negative active material layer slurry with a solid content (e.g., amount) of 44 wt %, and

except that the second negative active material layer slurry was prepared by mixing 98.57 wt % of the negative active material, 0.68 wt % of a styrene-butadiene rubber and 0.75 wt % of a carboxylmethylcellulose solution were mixed for 250 minutes and adding distilled water to the resulting mixture to prepare a second negative active material layer slurry with a solid content (e.g., amount) of 40 wt %.

A negative electrode was prepared by the same procedure as in Example 1, except for utilizing the first negative active material layer slurry and the second negative active material layer slurry.

Herein, the capillary number of the first negative active material layer slurry was 0.209, and the capillary number of the second active material layer slurry was 0.296.

### Comparative Example 3

A negative electrode was prepared by the same procedure as in Example 1, except that the first negative active material layer slurry was prepared by mixing 96.38 wt % of the negative active material utilized in Example 1, 2.72 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) were mixed for 200 minutes, and ad adding distilled water to the resulting mixture to prepare a first negative active material layer slurry with a solid content (e.g., amount) of 40 wt %, and

except that the second negative active material layer slurry was prepared by mixing 98.42 wt % of the negative active material utilized in Example 1, 0.68 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) were mixed for 200 minutes, and adding distilled water to the resulting mixture to prepare a second negative active material layer slurry with a solid content (e.g., amount) of 48 wt %.

A negative electrode was prepared by the same procedure as in Example 1, except for utilizing the first negative active material layer slurry and the second negative active material layer slurry.

Herein, the capillary number of the first negative active material layer slurry was 0.146, and the capillary number of the second active material layer slurry was 0.377.

### Comparative Example 4

A negative electrode was prepared by the same procedure as in Example 1, except that the first negative active material layer slurry was prepared by mixing 96.38 wt % of the negative active material utilized in Example 1, 2.72 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 250 minutes, and adding distilled water to the resulting mixture to prepare a first negative active material layer slurry with a solid content (e.g., amount) of 40 wt %, and

except that the second negative active material layer slurry was prepared by mixing 98.42 wt % of the negative active material utilized in Example 1, 0.68 wt % of a styrene-butadiene rubber, and 0.9 wt % of a carboxymethyl cellulose aqueous solution (concentration of carboxymethyl cellulose aqueous solution: 0.009 wt % of the aqueous solution is carboxymethyl cellulose and 99.001 wt % of the aqueous solution is water) for 250 minutes, and adding distilled water to the resulting mixture to prepare a second negative active material layer slurry with a solid content (e.g., amount) of 40 wt %.

Herein, the capillary number of the first negative active material layer slurry was 0.227, and the capillary number of the second active material layer slurry was 0.217.

The capillary numbers (Ca) of the negative active material layer slurries of Examples 1 to 3 and Comparative Examples 1 to 4 were summarized in Table 1.

TABLE 1

| | Ca of first negative active | Ca of second negative active |
|---|---|---|
| | material layer (lower) | material layer (upper) |
| Example 1 | 0.386 | 0.596 |
| Example 2 | 0.676 | 0.473 |
| Example 3 | 0.507 | 0.662 |
| Comparative | 0.201 | 0.223 |
| Example 1 | | |
| Comparative | 0.209 | 0.296 |
| Example 2 | | |
| Comparative | 0.146 | 0.377 |
| Example 3 | | |
| Comparative | 0.227 | 0.217 |
| Example 4 | | |

### Experimental Example 1: Measurement of Drag of End Portion

In the negative electrodes of Examples 1 to 3 and Comparative Examples 1 to 4, drags of the end portion of the coating region on the both (e.g., opposite) sides formed on the current collector, that is, the A plane and the B plane, was measured with a precision ruler. The results are shown in Table 2.

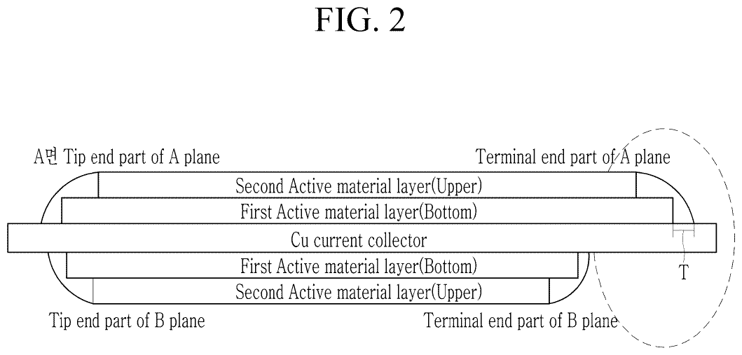

Even after the discharge of the slurry was completed, the second negative active material layer (upper) slurry that remained in the discharge part was longer and was pulled out to form the second negative active material layer (upper), so that any regions where the second negative active material layer slurry was only coated at the end of the coated region of first negative active material layer (lower) were formed shown in FIG. 2, and the length T was defined as a drag.

TABLE 2

Drag (mm)

| | A plane | B plane |
|---|---|---|
| Example 1 | 0.5 | 0.5 |
| Example 2 | 0.5 | 0.5 |
| Example 3 | 0.5 | 0.5 |
| Comparative | 3.2 | 9.5 |
| Example 1 | | |
| Comparative | 2 | 3.9 |
| Example 2 | | |
| Comparative | 10 | 10 |
| Example 3 | | |
| Comparative | 2 | 2.5 |
| Example 4 | | |

As shown in Table 2, the negative electrodes according to Examples 1 to 3 utilizing the first negative active material layer slurry with the capillary number of 0.25 to 1.50 and the second negative active material layer slurry with the capillary number of 0.28 to 1.50 exhibited short drag length at both (e.g., opposite) sides of the coating region and were identical to each other.

However, the negative electrodes according to Comparative Examples 1 to 4, which utilized either the first negative active material layer slurry with the capillary number of less than 0.25 or the second negative active material layer slurry with the capillary number of less than 0.28, exhibited very long drag lengths and different drag length at of both (e.g., opposite) sides.

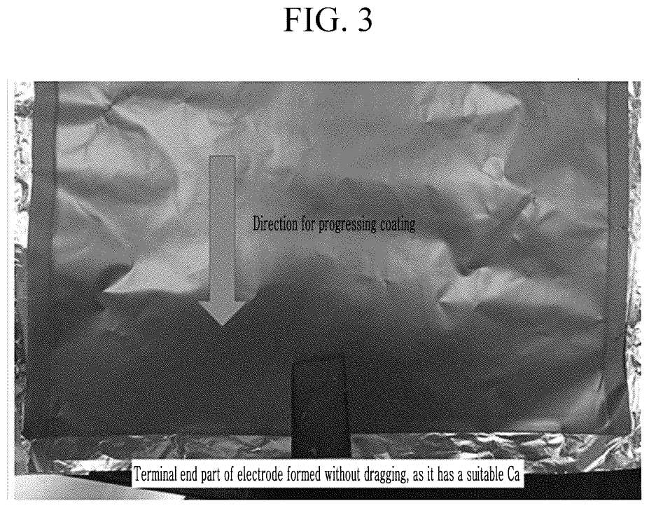

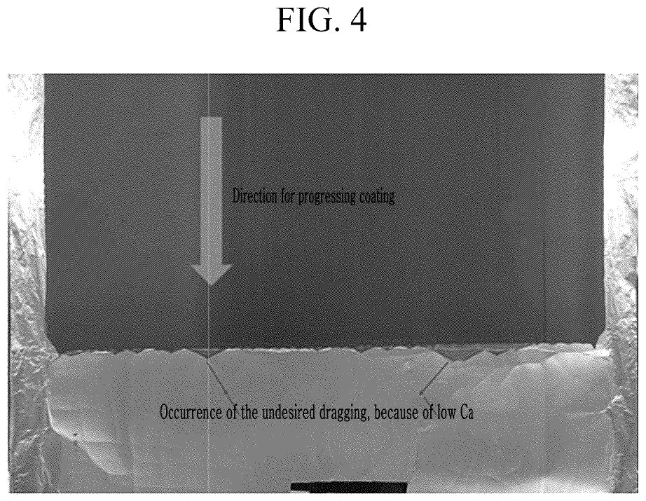

From the images shown in FIGS. 3 and 4, it can be seen that the negative electrode according to Example 1 rarely occurred (relatively low) drag and the negative electrode according to Comparative Example 1 severely occurred (relatively high) drag (FIG. 3: Example 1, FIG. 4: Comparative Example 1).

In the present disclosure, singular expressions may include plural expressions unless the context clearly indicates otherwise. It will be further understood that the terms “comprise(s),” “include(s),” or “have/has” if (e.g., when) utilized in the present disclosure, specify the presence of stated features, integers, steps, operations, elements, and/or components, but do not preclude the presence or addition of one or more other features, integers, steps, operations, elements, components, and/or groups thereof. The “/” utilized herein may be interpreted as “and” or as “or” depending on the situation.

Throughout the present disclosure, if (e.g., when) a component such as a layer, a film, a region, or a plate is mentioned to be placed “on” another component, it will be understood that it may be directly on another component or that another component may be interposed therebetween. In some embodiments, “directly on” may refer to that there are no additional layers, films, regions, plates, etc., between a layer, a film, a region, a plate, etc. and the other part. For example, “directly on” may refer to two layers or two members are disposed without utilizing an additional member such as an adhesive member therebetween.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” “one,” and “the” are intended to include the plural forms as well, unless the context clearly indicates otherwise. Further, the use of “may” if (e.g., when) describing embodiments of the present disclosure refers to “one or more embodiments of the present disclosure”.

In the present disclosure, if (e.g., when) particles (e.g., nanoparticles) are spherical, “size” indicates a particle diameter or an average particle diameter, and if (e.g., when) the particles are non-spherical, the “size” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. If (e.g., when) the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle if (e.g., when) the total number of particles is 100% in the distribution curve accumulated in the order of the smallest particle size to the largest particle size.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As utilized herein, the term “and/or” includes any and all combinations of one or more of the associated listed items. Throughout the disclosure, the expression “at least one of a, b or c”, “at least one of a-c”, “at least one of a to c”, “at least one of a, b, and/or c”, “at least one among a to c”, etc., indicates only a, only b, only c, both (e.g., simultaneously) a and b, both (e.g., simultaneously) a and c, both (e.g., simultaneously) b and c, all of a, b, and c, or variations thereof.

In the present specification, “including A or B”, “A and/or B”, etc., represents A or B, or A and B.

The negative electrode, the lithium battery, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

What is claimed is:

1. A method of preparing a negative electrode for a rechargeable lithium battery, the method comprising:
forming a coated portion on a current collector, wherein the coated portion comprises an active material layer; and
forming an uncoated region on the current collector, wherein the uncoated region does not include the active material layer and the coated portion and the uncoated portion are alternatively arranged,
wherein the coated portion is formed by coating a first negative active material layer composition having a capillary number of about 0.25 to about 1.50 on the current collector and coating a second negative active material layer composition having a capillary number of about 0.28 to about 1.50 on the first negative active material layer composition.

2. The method as claimed in claim 1, wherein the coating the first negative active material layer composition on the current collector and the coating the second negative active material layer composition on the first negative active material layer composition are concurrently performed.

3. The method as claimed in claim 1, wherein the first negative active material layer composition has a solid content of about 42 wt % to about 80 wt % based on the total 100 wt %, of the first negative active material layer composition, and
the second negative active material layer composition has a solid content of about 41 wt % to about 80 wt % based on the total 100 wt %, of the second negative active material layer composition.

4. The method as claimed in claim 1, wherein the first negative active material layer composition comprises a first thickener and an amount of the first thickener is about 0.006 wt % to about 0.012 wt % based on the total 100 wt %, of the first negative active material layer composition, and
the second negative active material layer composition comprises a second thickener and an amount of the second thickener is about 0.007 wt % to about 0.013 wt % based on the total 100 wt %, of the second negative active material layer composition.

5. The method as claimed in claim 1, wherein the first negative active material layer composition has a capillary number of about 0.25 to about 0.82.

6. The method as claimed in claim 1, wherein the second negative active material layer composition has a capillary number of about 0.28 to about 0.85.

7. The method as claimed in claim 1, wherein a difference between a capillary number of the first negative active material layer composition and a capillary number of the second negative active material layer composition is about 0.03 to about 1.25.

8. A negative electrode for a rechargeable lithium battery, the negative electrode being prepared according to claim 1.

9. A rechargeable lithium battery, comprising:
the negative electrode of claim 8;
a positive electrode; and
an electrolyte.

10. A rechargeable lithium battery, comprising:
a negative electrode prepared according to claim 1;
a positive electrode; and
an electrolyte.
